(19) United States
(12) Patent Application Publication
(10) Pub. No.: US 2004/0148547 A1
(43) Pub. Date: Jul. 29, 2004

(54) UPS-based file data storage apparatus and computer program products

(76) Inventors: Jim Thompson, Raleigh, NC (US); Brian R. Young, Raleigh, NC (US)

Correspondence Address: MYERS BIGEL SIBLEY & SAJOVEC, PO BOX 37428, RALEIGH, NC, 27627, US

(21) Appl. No.: 10/353,698

(22) Filed: Jan. 28, 2003

(51) Int. Cl. H04L 1/22

(52) U.S. Cl. 714/22

(57) ABSTRACT

A file data storage apparatus includes an uninterruptible power supply (UPS) and a file data storage device. The file data file data storage device may include at least one of electronic storage, magnetic storage, and optical storage. The file data storage apparatus may further include a common communications transceiver circuit configured to provide communications for the UPS and the file data storage device. A computer-based apparatus capable of interfacing with such a file data storage apparatus includes a computer including a communications port configured to be coupled to both a UPS and an external file storage medium and to communicate with the external file storage medium and the UPS using a common communications transceiver. The computer may be configured to implement a UPS-based file data storage agent. A computer program product for providing a UPS-based file data storage comprises program code configured to implement a UPS-based file data storage agent in a computer.

### BACKGROUND OF THE INVENTION

The present invention relates to computer apparatus, methods and computer program products, and more particular, to data storage apparatus, methods and computer program products.

In today's automated office environments, an untold number of letters, emails, spreadsheets and other important documents are lost every day. Unintentional losses arising from such events as natural disasters and equipment failures can lead to losses in productivity and continuity. Some studies indicate that natural disasters account for 3 percent of data loss, while hardware or system malfunction account for 44 percent, human error 32 percent, program malfunction 14 percent, and computer viruses 7 percent.

Theft or intentional destruction of documents can also bring about loss of information. For example, when an employee leaves an organization, either voluntarily or involuntarily, the employee may abscond with and/or destroy valuable data, and the organization may have difficulty capturing or reconstructing information used by the departing employee. Such information loss can ultimately lead to a loss in project momentum, diminished property rights and/or increased legal exposure.

Although backup systems have been developed to protect data, these system can have significant limitations. For example, uninterruptible power supplies (UPSs) can be used to provide backup power in the case of loss of utility service, but such devices may not guard against software or computer hardware failures, human error and/or human malfeasance. File backup systems and software can be used to preserve copies of data in multiple media, e.g., on magnetic tape or similar robust media, but its actions may not be coordinated to respond to and/or prevent particular events, e.g., equipment failures or wrongdoing. In addition, such backup tools are often inconsistently distributed and used in organizations, especially among remote or mobile workers that may have less IT (information technology) support. Accordingly, there is an ongoing need for improved data protection techniques.

### SUMMARY OF THE INVENTION

According to some embodiments of the invention, this need can be provided by a file data storage apparatus including a housing, an uninterruptible power supply (UPS) positioned in the housing, and a file data storage device positioned in the housing, powered by the UPS, configured to be coupled to a computer to receive file data therefrom, and operative to store the received file data. The file data storage apparatus may further include a common communications transceiver circuit configured to provide common communications for the UPS and the file data storage device, for example, a wireline transceiver circuit that conforms, for example, to FireWire or Universal Serial Bus (USB) wireline standards, or a wireless (e.g., optical, infrared, radio) transceiver circuit.

In further embodiments of the invention, a computer-based apparatus capable of interfacing with such a file data storage apparatus is provided. In some embodiments, the apparatus includes a computer including a communications port configured to be coupled to both a UPS and an external file storage medium and to communicate with the external file storage medium and the UPS at a common communications transceiver. The computer may be configured to implement a UPS-based file data storage agent that is operative to communicate with the UPS and the external file storage medium via the common communications transceiver. The file data storage agent may be operative to transfer file data from the computer to the external storage medium responsive to a status of the UPS. The file data storage agent may be further operative to secure file data for storage in the external storage medium, e.g., by password protection and/or encryption. In still further embodiments, a computer program product for providing a UPS-based file data storage comprises program code configured to implement a UPS-based file data storage agent in a computer, the UPS-based file data storage agent operative to communicate with a UPS and an external storage medium that use a common communications transceiver.

### BRIEF DESCRIPTION OF THE DRAWINGS

FIG. 1 illustrates a UPS-based file data storage apparatus according to some embodiments of the invention.

FIG. 2 illustrates a UPS-based file data storage apparatus according to further embodiments of the invention.

FIG. 3 illustrates a computer apparatus configured to provide a UPS-based file data storage agent according to some embodiments of the invention.

FIG. 4 illustrates an exemplary user interface for a UPS-based file data storage agent according to further embodiments of the invention.

FIG. 5 illustrates exemplary operations according to further embodiments of the present invention.

FIG. 6 illustrates a UPS-based file data storage apparatus according to further embodiments of the invention.

### DETAILED DESCRIPTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements. It will be understood that when an element is referred to as being “connected” or “coupled” to another element, it can be directly connected or coupled to the other element or intervening elements may be present.

Embodiments of the invention described herein involve storage of computer “file data” in association with UPS operations. As used herein, “file data” includes data that retains, reflects or otherwise represents a file structure maintained by a computer. For example, “file data” may include, but is not limited to, replicas of a file structure, including file headers and other file organizational parameters that may be stored in the file structure, as well as encrypted, compressed, scrambled or otherwise processed representations of such files.

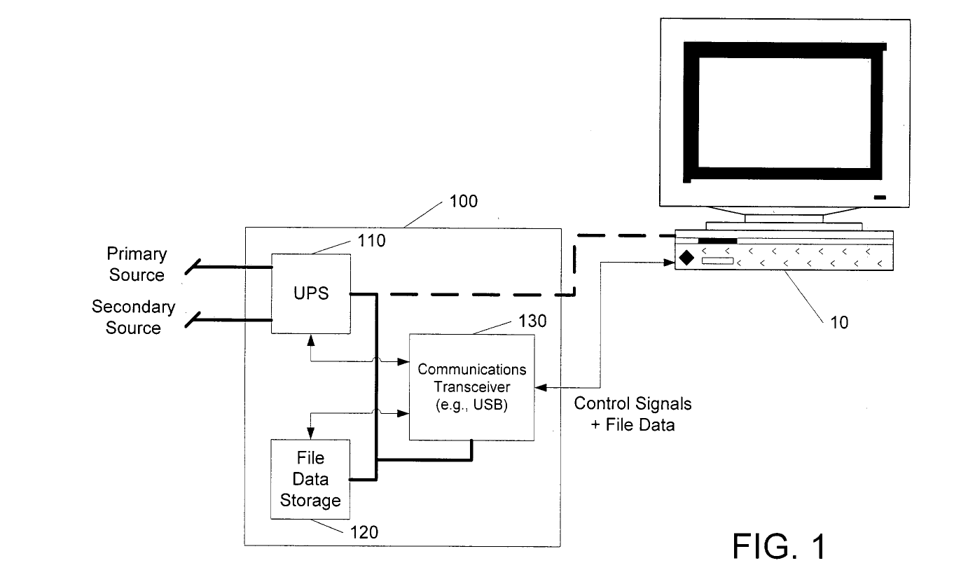

In the present application, FIGS. 1-6 are diagrams illustrating exemplary apparatus and operations according to embodiments of the present invention. It will be understood that operations depicted in the diagrams, and combinations thereof, may be implemented using one or more electronic circuits, such as a circuits included in a communications circuit of a networked device such as UPS or a computer that is operatively associated with a UPS. It will also be appreciated that, in general, operations depicted in the diagrams, and combinations thereof, may be implemented in one or more electronic circuits, such as in one or more discrete electronic components, one or more integrated circuits (ICs), one or more application specific integrated circuits (ASICs), and application specific circuit modules, as well as by computer program instructions which may be executed by a computer or other data processing apparatus, such as a microprocessor or digital signal processor (DSP), to produce a machine such that the instructions which execute on the computer or other programmable data processing apparatus create electronic circuits or other means that implement the specified operations. The computer program instructions may also be executed on one or more computers or other data processing apparatus to cause a series of actions to be performed by the computer(s) or other programmable apparatus to produce a computer implemented process that includes the specified operations.

The computer program instructions may also be embodied in the form of a computer program product in a computer-readable storage medium, i.e., as computer-readable program code embodied in the medium for use by or in connection with an instruction execution system. The computer-readable storage medium may include, but is not limited to, electronic (e.g., semiconductor, molecular), magnetic, optical or other storage media, such as a magnetic or optical disk or an integrated circuit memory device. For example, the computer program instructions may be embodied in memory included in a computer. Accordingly, blocks of the diagrams of FIGS. 1-6 support electronic circuits and other apparatus that perform the specified operations, acts for performing the specified operations, and computer program products configured to perform the specified operations.

FIG. 1 illustrates an exemplary UPS-based file data storage apparatus 100 according to some embodiments of the present invention. The apparatus 100 includes a UPS 110 and a file data storage device 120, e.g., a disk drive, flash memory or other data storage device. The UPS 110 and the file data storage device 120 are operatively associated with a communications transceiver circuit 130, e.g. a FireWire or Universal Serial Bus (USB) transceiver circuit, that communicates control signals between a computer 10 and the UPS 110, and that communicates file data between the computer 10 and the file data storage device 120. As shown, the UPS 110 can provide power for the file data storage device 120, the communications circuit 130, and/or the computer 10. It will be appreciated that power delivered to these components can be delivered in different forms e.g., AC or DC, and/or at different voltage levels.

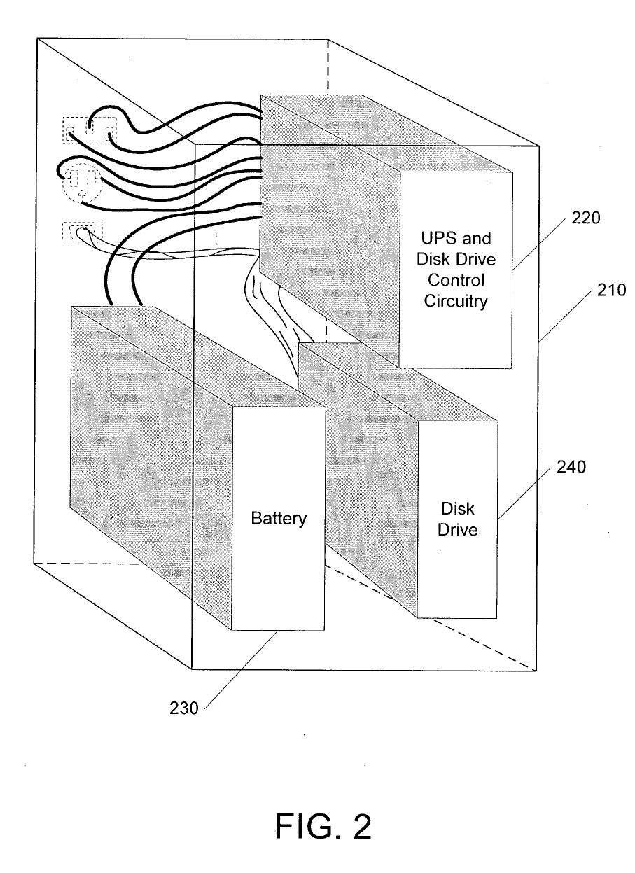

It will be appreciated that the UPS 110 may comprise any of a number of different kinds of power supply systems, including but not limited to, on-line, standby, line-interactive, and backup power supply systems. It will be appreciated that the components illustrated in FIG. 1 may be integrated in a number of different ways. For example, FIG. 2 shows an apparatus 200 suited for use, for example, with a personal computer or workstation. The apparatus 200 includes a housing 210 that houses UPS and disk drive control circuitry 220, e.g., power conversion and communications transceiver circuitry performing some of the functions of the UPS 110, file data storage device 120 and communications transceiver circuit 130 of FIG. 1. The apparatus 200 also includes a disk drive 240 on which file data may be stored (e.g., in a secured manner), and a battery 230 that supplies backup power under control of the UPS and disk drive control circuitry 220. For example, the apparatus 200 may be used with a personal computer or other type of computer workstation powered by the UPS circuitry of the apparatus 200, and may provide a secure (e.g., password protected and/or encrypted) “vault” or “strongbox” for storage of sensitive and/or critical information. It will be appreciated that the apparatus 200 is provided for exemplary purposes, and that apparatus according to the invention may be configured in other ways, including other arrangements of circuit functions.

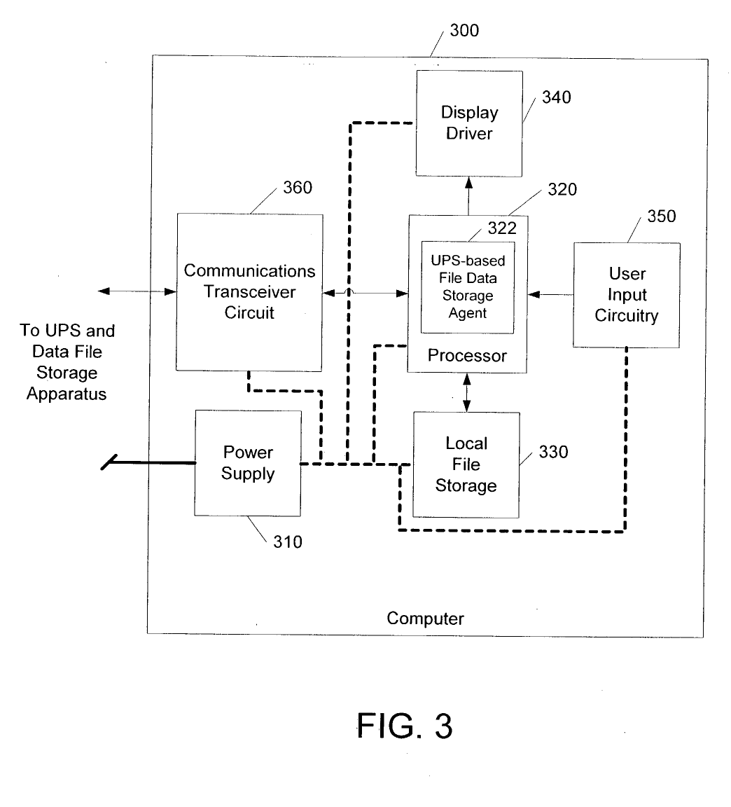

FIG. 3 illustrates a computer apparatus 300 according to further embodiments of the invention, which may be used to control a UPS-based file data storage apparatus, such as the apparatus 100, 200 of FIGS. 1 and 2. The computer apparatus 300 includes a power supply 310 that receives AC power from, for example, a UPS, such as the UPS 110 of the apparatus 100. The power supply 310 provides power (e.g., DC power) to a central processing unit (CPU) 320, a disk drive 330, a display driver circuit 340, user input circuitry 350, and a communications transceiver circuit 360. The display driver circuit 340 may be used to control a monitor or other display device, in a manner known to those skilled in the art. The disk drive 330 may be used to store data files that are created and manipulated by the CPU 320. The user input circuitry 350 may include, for example, circuitry for controlling and/or monitoring a device, such as a mouse, keyboard, joystick, or the like. The communications transceiver circuit 360 may include circuitry configured to provide a wireline, optical, wireless or other communications interface for the computer 300, such as an Ethernet, USB, FireWire, IEEE 802.11 (a)-(b), Bluetooth, or other interface.

The CPU 320, which may include associated memory, is configured to implement a UPS-based file data storage agent 322 that communicates file data with an external storage medium, for example, the storage medium of a UPS-based file storage apparatus, such as the 100, 200 of FIGS. 1 and 2, via the communications transceiver circuit 360. For example, the UPS-based file data storage agent 322 may be configured to convey file data between the external storage medium and the disk drive 330. For example, the file data storage agent 322 may be operative to convey file data responsive to status information received from the UPS of the UPS-based file data storage apparatus, for example, information indicative of a power failure or other events, such as the passage of a predetermined time interval, a status change in the computer 300, or the like.

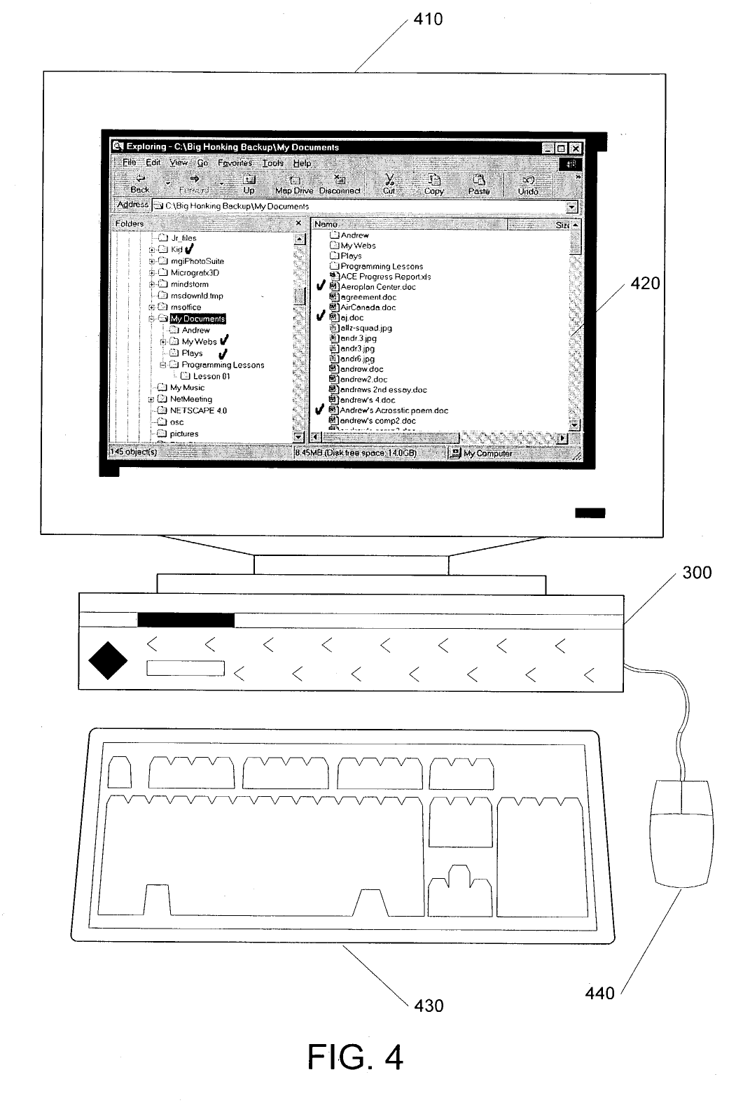

An example of a user interface that may be provided by the UPS-based file data storage agent 322 is illustrated in FIG. 4. In particular, according to some embodiments of the invention, a file data storage agent resident at a computer 400 can generate a user window 420 on a display area of a monitor 410 coupled to the computer 400. As shown, the user interface may provide a capability to mark selected files (indicated by the check marks) responsive to user inputs entered at a keyboard 430 and/or mouse 440. The file data storage agent may responsively store data from the marked files in an external storage medium of a UPS-based file data storage apparatus, such as the apparatus 100, 200 illustrated in FIGS. 1 and 2, coupled to the computer 400.

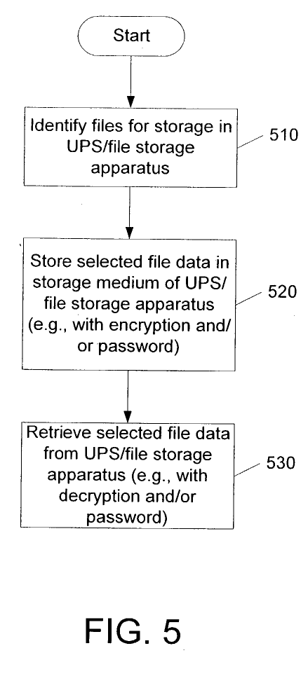

FIG. 5 illustrates exemplary operations that may be performed by apparatus according to some embodiments of the invention, such as the apparatus 100, 200 of FIGS. 1 and 2. Files that are to be stored in a UPS-based file data storage apparatus are identified (Block 510), e.g., using an user interface along the lines described above with reference to FIG. 4. Data from the identified files are then stored in the combined UPS and data file storage apparatus (Block 520). For example, as discussed above, data transfer may be triggered by a status change of the UPS of the file data storage apparatus, e.g., by a failure or degradation of an AC power source that feeds the UPS, or other event(s). Secure storage may be achieved by encrypting the file data and/or password protecting the data. The stored file data may be later retrieved using, for example, an appropriate decryption algorithm and/or password (Block 530).

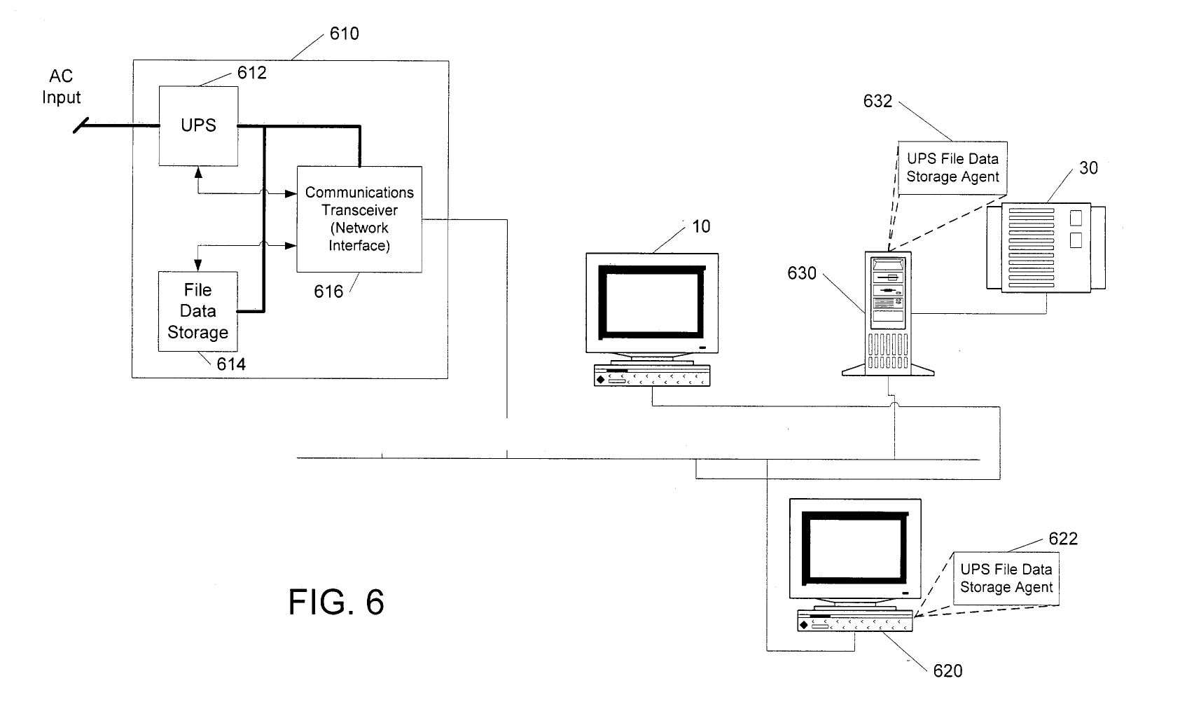

FIG. 6 illustrates another application of a UPS-based file data storage apparatus 610 according to further embodiments of the invention. The UPS-based file data storage apparatus 610 is coupled to one or more file data storage agents 622, 632 resident at networked computers, e.g., a workstation 620 and a server 630. The UPS-based file data storage apparatus 610 include a UPS 612 that powers a data storage device 614 and a communications transceiver circuit 616, e.g., a network card, that provides communications of control signals for the UPS 612 and file data for the file data storage device 612. The apparatus 610 can perform file data storage functions for the networked computers 620, 630 in a manner similar to that described above with reference to FIGS. 1-5.

It will be further appreciated that in a networked environment, a file data storage agent resident at one computer may be operative to control storage of data resident at the other computer, and vice versa. It will be further understood that a file data storage agent also may be distributed across multiple computers. For example, a portion of a file data storage agent that provides a user interface for selecting files for storage, e.g., the functionality illustrated in FIG. 4, may be provided by a first component resident at a first computer, while a portion that provides file transfer functions may be provided by a second component resident at a second computer.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A file data storage apparatus, comprising:
a housing;
an uninterruptible power supply (UPS) positioned in the housing; and
a file data storage device positioned in the housing, powered by the UPS, configured to be coupled to a computer to receive file data therefrom, and operative to store the received file data.

2. A file data storage apparatus according to claim 1, further comprising a common communications transceiver circuit positioned in the housing and configured to provide communications for the UPS and the file data storage device.

3. A file data storage apparatus according to claim 2, wherein the common communications transceiver circuit is configured to be coupled to an external communications port of the computer.

4. A file data storage apparatus according to claim 3, wherein the communications transceiver circuit comprises at least one of a wireline transceiver circuit and a wireless transceiver circuit.

5. A file data storage apparatus according to claim 1, wherein the file data storage device comprises at least one of electronic storage, magnetic storage, and optical storage.

6. A file data storage apparatus according to claim 1, wherein the file storage device comprises a non-volatile storage medium.

7. A file data storage apparatus according to claim 1, wherein the UPS is configured to be coupled to the computer to provide power thereto.

8. A file data storage apparatus according to claim 1, wherein the file data storage device is configured to be coupled to at least one of a desktop computer, a laptop computer, a notebook computer and a computer workstation.

9. A file data storage apparatus, comprising:
an uninterruptible power supply (UPS);
a file data storage device powered by the UPS; and
a communications transceiver circuit configured to provide a common computer interface for the UPS and the file data storage device.

10. A file data storage apparatus according to claim 9, wherein the communications transceiver circuit is configured to be coupled to an external communications port of a computer.

11. A file data storage apparatus according to claim 10, wherein the communications transceiver circuit comprises at least one of a wireline transceiver circuit and a wireless transceiver circuit.

12. A file data storage apparatus according to claim 9, wherein the UPS, the file data storage device and the communications transceiver circuit are integrated in a common housing.

13. An apparatus, comprising:
a computer including a communications port configured to be coupled to both a UPS and an external file storage medium and to communicate with the external file storage medium and the UPS that share a communications transceiver circuit.

14. An apparatus according to claim 13, wherein the computer is configured to implement a UPS-based file data storage agent that is operative to communicate with the UPS and the external file storage medium via the common communications transceiver.

15. An apparatus according to claim 14, wherein the UPS-based file data storage agent is operative to transfer file data from the computer to the external storage medium responsive to a status of the UPS.

16. An apparatus according to claim 14, wherein the UPS-based file data storage agent is operative to secure file data for storage in the external storage medium.

17. An apparatus according to claim 16, wherein the UPS-based file data storage agent is operative to create an access code for file data stored in the external storage medium and to convey the created access code to a control circuit of the external storage medium.

18. An apparatus according to claim 16, wherein the UPS-based file data storage agent is operative to apply an encryption algorithm to file data stored at the computer and to convey the encrypted file data to the external storage medium.

19. An apparatus according to claim 15, wherein the UPS-based file data storage agent is operative to decrypt file data retrieved from the external storage medium.

20. An apparatus according to claim 16, wherein the UPS-based file data storage agent is operative to provide a security code to a control circuit of the external storage medium to access file data stored in the external storage medium.

21. An apparatus according to claim 14, wherein the UPS-based file data storage agent is operative to establish a user interface at the computer and to mark selected files resident at the computer for storage in the external storage medium responsive to a user input.

22. A computer program product comprising program code embodied in a computer-readable storage medium, the computer program code comprising:
program code configured to implement a UPS-based file data storage agent in a computer, the UPS-based file data storage agent operative to communicate with a UPS and an external storage medium that share a communications transceiver circuit.

23. A computer program product according to claim 22, wherein the UPS-based file data storage agent is operative to transfer file data from the computer to the external storage medium responsive to a status of the UPS.

24. A computer program product according to claim 22, wherein the UPS-based file data storage agent is operative to secure file data for storage in the external storage medium.

25. A computer program product according to claim 24, wherein the UPS-based file data storage agent is operative to create an access code for file data stored in the external storage medium and to convey the created access code to a control circuit of the external storage medium.

26. A computer program product according to claim 24, wherein the UPS-based file data storage agent is operative to apply an encryption algorithm to file data stored at the computer and to convey the encrypted file data to the external storage medium.

27. A computer program product according to claim 24, wherein the UPS-based file data storage agent is operative to decrypt file data retrieved from the external storage medium.

28. A computer program product according to claim 24, wherein the UPS-based file data storage agent is operative to provide a security code to a control circuit of the external storage medium to access file data stored in the external storage medium.

29. A computer program product according to claim 22, wherein the computer program code further comprises program code configured to establish a user interface at the computer and to mark selected data files resident at the computer for storage in the external storage medium responsive to a user input.

30. A method of maintaining a file data storage apparatus, the method comprising:
communicating control signals and file data between a computer and respective ones of a UPS and a storage medium that share a communications transceiver circuit.

31. A method according to claim 30, further comprising powering the computer and/or the storage medium from the UPS.

32. A method according to claim 30, wherein the communications transceiver circuit comprises at least one of a wireline transceiver circuit and a wireless transceiver circuit.

33. A method according to claim 30, further comprising housing the UPS and the storage medium in a common housing.
